(19) United States
(12) Patent Application Publication
(10) Pub. No.: US 2026/0101881 A1
(43) Pub. Date: Apr. 16, 2026

(54) Apparatus for Storing Ancillary Items Used by Angler

(71) Applicant: Toit Fishing Limited, Hartford (GB)

(72) Inventor: Warren Shawn du Toit, Hartford (GB)

(21) Appl. No.: 19/337,319

(22) Filed: Sep. 23, 2025

(30) Foreign Application Priority Data
Oct. 10, 2024 (GB) 2414909.8

(51) Int. Cl. A01K 97/00

(52) U.S. Cl. CPC A01K 97/00

(57) ABSTRACT

A rod holder adaptor apparatus (10) for storing an ancillary item used by an angler on a fishing boat, comprising: an elongate anchoring member (20) configured to be anchored in a fishing rod holder on the fishing boat; a cup-like receptacle (40) mounted on one axial end (22) of the elongate anchoring member (20); and a preformed component (50) coupled to the cup-like receptacle (40), the preformed component having a profile configured to retain the ancillary item in the receptacle when placed therein. The elongate anchoring member (20) comprises: a shaft (24); a radially expandable resilient member (26) mounted on the shaft (22); and a compression mechanism (28) for radially expanding the resilient member (26) in order to achieve a friction fit in the fishing rod holder (14).

### TECHNICAL FIELD

This relates to an apparatus for storing an ancillary item used by an angler on a fishing boat or kayak.

### TECHNICAL BACKGROUND

Fishing boats used for recreational or leisure fishing with a rod and line typically have numerous fishing rod holders for an angler to use. There are many different types of fishing rod holders, including flush mounted rod holders typically pre-installed installed in the gunwale of a boat, and removable rod holders typically retro-fitted to a suitable part of a boat such as a rail. Each fishing rod holder defines a bore for receiving a butt section of a fishing rod after its line has been cast, such that the fishing rod is held securely in an upright orientation until it is regathered by the angler. At any one time, there will usually be at least one empty fishing rod holder on a boat.

In addition to the fishing rods per se, a variety of ancillary items will be used by an angler when fishing. Such ancillary items may include: well-known fishing tools, such as pliers, scissors, a knife, a bait needle etc; and well-known fishing accessories, such as lures and slow-pitch jigs. Such ancillary items may also include everyday items such as a water bottle or a travel mug. Anglers will sometimes use a dedicated sheath to store certain fishing tools and accessories, but otherwise resort to using their pockets or a universal repository such as a bucket on the deck of the boat where tools and accessories and any everyday items may be loosely stored together.

The present apparatus seeks to address at least some of the above issues by providing improved storage for such ancillary items.

### SUMMARY

In accordance with a first aspect, there is provided apparatus for storing an ancillary item used by an angler on a fishing boat or kayak, comprising: an elongate anchoring member configured to be anchored in a fishing rod holder on the fishing boat; a cup-like receptacle mounted on one axial end of the elongate anchoring member; and a preformed component coupled to the cup-like receptacle, the preformed component having a profile configured to retain the ancillary item in the receptacle when placed therein.

The elongate anchoring member may be substantially cylindrical, like the butt end of a fishing rod, in order to fit the fishing rod holder. The elongate anchoring member may comprise a shaft and a resilient member mounted on the shaft. The elongate anchoring member may further comprise a compression mechanism for radially expanding the resilient member. Such a compression mechanism may be used to adjust the outer diameter of the resilient member, so the elongate anchoring member may be adjusted to achieve a snug fit in fishing rod holders with different diameter bores. The compression mechanism may comprise a pair of opposed jaws coupled together by a screw-threaded rod extending axially through the resilient member, with rotation of the screw-threaded rod relative to at least one jaw adjusting the spacing between the opposed jaws. At least one jaw may have a frustoconical surface to help radially expand the resilient member when compressed between the pair of jaws.

The profile of the preformed component may correspond to at least part of the ancillary item, so the latter is a tight or friction fit in the former. In this way, the ancillary item will be retained securely when placed in the apparatus by the angler. The profile of the preformed component may be configured to retain more than one ancillary item. The preformed component may be removably coupled to the cup-like receptacle, so that it may readily be replaced by another preformed component with a different profile for retaining a different ancillary item.

The preformed component may cover at least part of an open end of the cup-like receptacle, and at least part of the profile may extend into the cup-like receptacle. The preformed component may be configured as a cap or lid, having a peripheral edge which fits over a rim of the cup-like receptacle. The peripheral edge may be resilient. The peripheral edge and the rim of the cup-like receptacle may define a snap-fit closure for securely holding the preformed cap on the cup-like receptacle. Alternatively, other types of inter-fitting profiles (such as mating screw-threads) may be provided to securely hold the preformed cap on the cup-like receptacle.

The preformed component may comprise a body configured to fit in the cup-like receptacle, and one end of the body may have an outer surface substantially corresponding to an inner surface of the cup-like receptacle. In this way, the preformed component may be a snug fit in the cup-like receptacle. The profile may be formed in an opposite end of the body, and at least part of the profile may extend into the cup-like receptacle.

The cup-like receptacle may have a side wall with at least one aperture therethrough for attaching a tether or lanyard to the apparatus, either directly or via a clip such as a carabiner, snap hook, split ring or quicklink. In this way, the ancillary item may remain tethered to the apparatus even when in use by the angler.

In accordance with a second aspect, there is provided a kit of parts for storing ancillary items used by an angler on a fishing boat, comprising: apparatus comprising an elongate anchoring member configured to be anchored in a fishing rod holder on the fishing boat; and a cup-like receptacle mounted on one axial end of the elongate anchoring member; and a plurality of preformed components configured to be interchangeably coupled to the cup-like receptacle, the plurality of preformed components having different profiles which correspond to different ancillary items such that, when one of the preformed components is coupled to the cup-like receptacle, the respective profile is configured to retain a corresponding ancillary item in the cup-like receptacle when placed therein.

Any of the optional features of the first aspect apparatus may be optional features of the second aspect of the apparatus.

### BRIEF DESCRIPTION OF THE DRAWINGS

An embodiment of the apparatus will now be described by way of example and with reference to the accompanying figures, in which:

FIG. 1 is a schematic perspective view of a rod holder adaptor apparatus according to an embodiment of the apparatus, in use and in situ in a fishing rod holder.

FIG. 2 is an exploded view showing components of the rod holder adaptor apparatus of FIG. 1.

FIG. 3 is a side view of the apparatus of FIG. 1.

FIG. 4 is an end view of the apparatus of FIG. 1.

FIGS. 5A, 5B and 5C show alternative forms of a part of the apparatus of FIG. 1.

### DESCRIPTION OF SPECIFIC EMBODIMENT

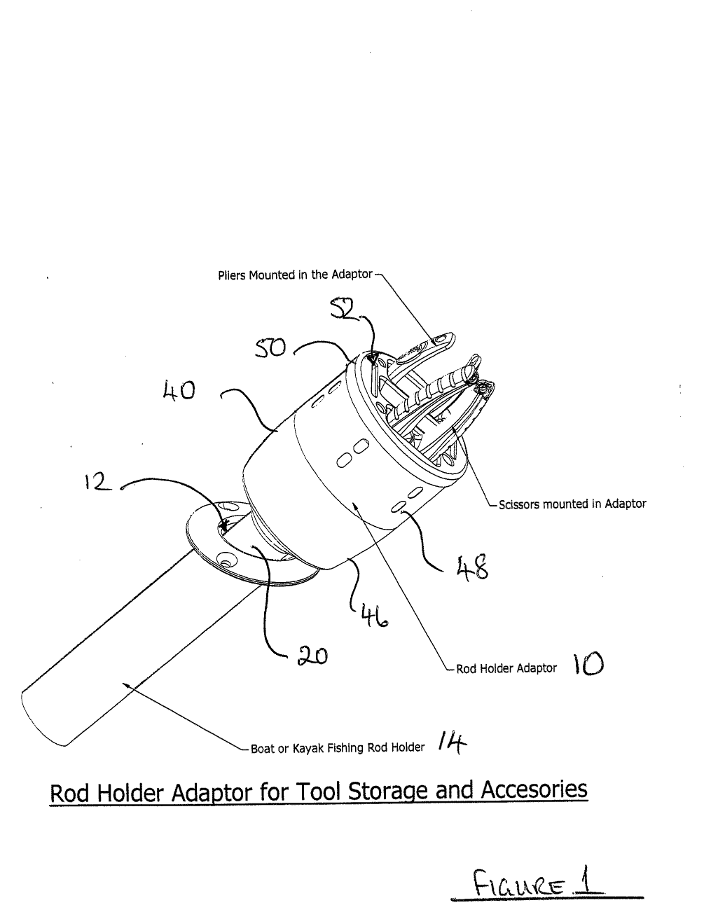

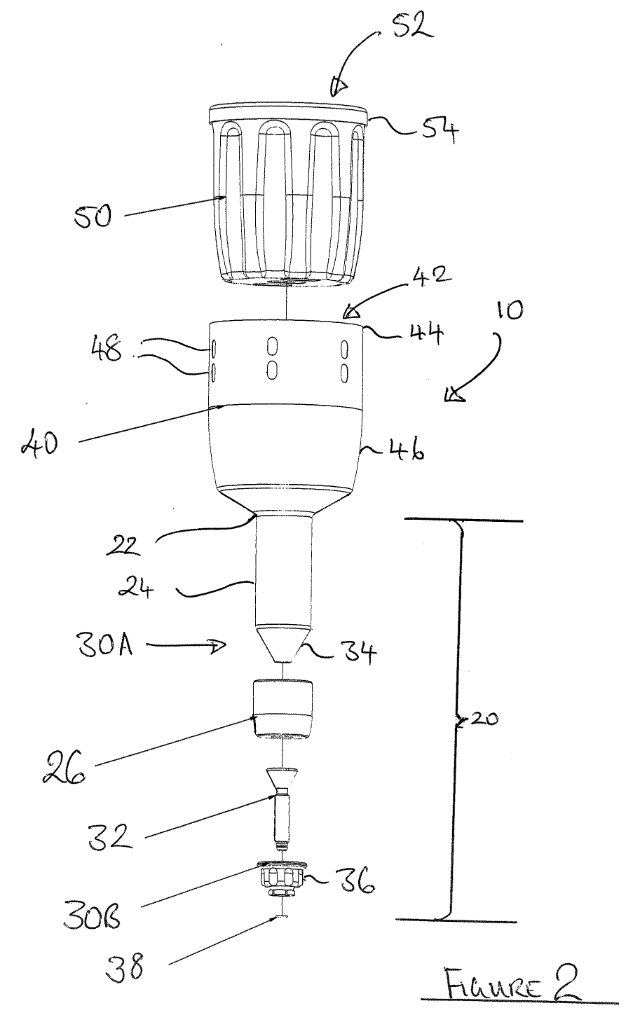

FIG. 1 illustrates schematically a rod holder adaptor apparatus 10 storing ancillary items (for example, pliers and scissors are illustrated) used by an angler on a fishing boat or kayak. The apparatus 10 is schematically illustrated anchored in the bore 12 of a fishing rod holder 14 of the kind commonly found on a fishing boat. The apparatus 10 comprises an elongate anchoring member 20 (shown anchored in the bore 12 of the fishing rod holder 14); a cup-like receptacle 40 mounted on one axial end 22 of the elongate anchoring member 20; and a preformed component 50 coupled to the cup-like receptacle 40. The preformed component 50 has a profile 52 defining slots 54 and/or pockets 56 which are configured to retain a range of preselected ancillary items in the cup-like receptacle 40 when placed therein.

The elongate anchoring member 20 is substantially cylindrical, like the butt end of a fishing rod, in order to fit the bore 12 of the fishing rod holder 14. The elongate anchoring member 20 comprises a shaft 24 and a radially expandable resilient member 26 mounted on the shaft 22, spaced from the axial end 22. The elongate anchoring member 20 also comprises a compression mechanism 28 for radially expanding the resilient member 26 in order to achieve a friction fit in the bore 12 of the fishing rod holder 14. The compression mechanism 28 comprises a pair of opposed jaws 30A, 30B coupled together by a screw-threaded rod 32 extending axially through the resilient member 26. One jaw 30A is positioned on the shaft 22 and has a frustoconical surface 34, and the other jaw 30B is part of a nut 36 threaded on the screw-threaded rod 32. Rotating the nut 36 relative to the screw-threaded rod 32 controls the spacing between the opposed jaws 30A, 30B, and hence compression applied to and the resulting radial expansion of the resilient member 26. A nut retainer 38 is provided to prevent the nut 36 from accidentally becoming detached from the screw-treaded rod 32 when unscrewed.

The cup-like receptacle 40 is capped by the preformed component 50, with at least part of the profile 52 extending into the cup-like receptacle 40. The cup-like receptacle 40 has an open end 42 defined by a rim 44. The preformed component 50 has a peripheral edge 54 which fits over the rim 44, covering the open end 42 of the cup-like receptacle 40. The peripheral edge 54 and the rim 44 have inter-fitting profiles (not shown) which form a snap-fit closure for removably coupling the preformed component 50 to the cup-like receptacle 40.

The cup-like receptacle 40 has a side wall 46 with multiple apertures 48 therethrough for attaching a tether or lanyard to the apparatus 10, either directly or via a clip such as a carabiner (not shown).

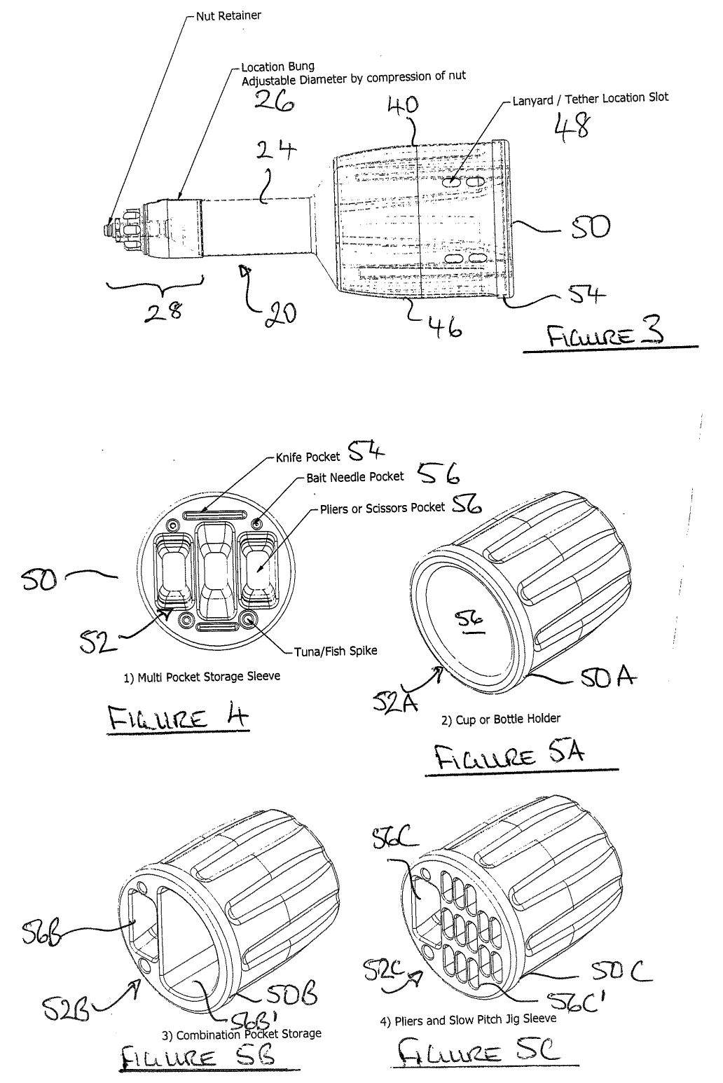

FIGS. 5A, 5B and 5C show alternative preformed components 50A, 50B, 50C each with a different profile 52A, 52B, 52C for retaining a different ancillary item. By releasing the snap-fit closure, the preformed component 50 may be removed from the cup-like receptacle 40, and replaced by another one of the preformed components 50A, 50B, 50C. For example, FIG. 5A shows a preformed component 50A with a profile 52A defining a single pocket 56 of circular cross-section for retaining a drinking cup or bottle. FIG. 5B shows a preformed component 50B with a profile 52B defining two pockets of different shapes and sizes, with one pocket 56B of rectangular cross-section for a pair of pliers and the other pocket 56Bʹ of D-shaped cross-section. FIG. 5C shows a preformed component 50C with a profile 52C defining multiple pockets, with one pocket 56C of rectangular cross-section for a pair of pliers, and the other pockets 56Cʹ being configured to retain slow-pitch jigs.

### Incorporated by Reference

The entire content of each document listed below is incorporated by reference into this document (the documents below are collectively referred to as the “incorporated documents”). If the same term is used in both this document and one or more of the incorporated documents, then it should be interpreted to have the broadest meaning imparted by any one or combination of these sources unless the term has been explicitly defined to have a different meaning in this document. If there is an inconsistency between any incorporated document and this document, then this document shall govern. The incorporated subject matter should not be used to limit or narrow the scope of the explicitly recited or depicted subject matter.

Benefit/priority patent documents incorporated by reference:

– GB Pat. App. No. 2414909.8, titled “Apparatus for Storing Ancillary Items Used by Angler,” filed on 10 Oct 2024.

1. An apparatus configured to store an ancillary item used by an angler on a fishing boat, comprising:
an elongate anchoring member configured to be anchored in a fishing rod holder on the fishing boat;
a cup-like receptacle mounted on one axial end of the elongate anchoring member; and
a preformed component coupled to the cup-like receptacle, the preformed component having a profile configured to retain the ancillary item in the cup-like receptacle when placed therein,
wherein the elongate anchoring member comprises: a shaft; a resilient member mounted on the shaft; and a compression mechanism configured to radially expand the resilient member.

2. The apparatus according to claim 1, wherein the compression mechanism comprises a pair of opposed jaws coupled together by a screw-threaded rod extending axially through the resilient member, with rotation of at least one of the opposed jaws relative to the screw-threaded rod adjusting the spacing between the opposed jaws.

3. The apparatus according to claim 2, wherein at least one jaw has a frustoconical surface to help radially expand the resilient member when compressed between the pair of opposed jaws.

4. The apparatus according to claim 1, wherein the profile of the preformed component corresponds to at least part of the ancillary item, so the ancillary item is a tight or friction fit in the preformed component.

5. The apparatus according to claim 1, wherein the preformed component is removably coupled to the cup-like receptacle, so that the preformed component can be readily replaced by another preformed component with a different profile to retain a different ancillary item.

6. The apparatus according to claim 1, wherein the preformed component covers at least part of an open end of the cup-like receptacle.

7. The apparatus according to claim 6, wherein the preformed component is configured as a cap or lid, having a peripheral edge which fits over a rim of the cup-like receptacle.

8. The apparatus according to claim 7, wherein the peripheral edge and the rim of the cup-like receptacle define a snap-fit closure configured to securely hold the preformed component on the cup-like receptacle.

9. The apparatus according to claim 1, wherein the cup-like receptacle has a side wall with at least one aperture through which a tether or lanyard can be coupled to the apparatus, either directly or via a clip.

10. A kit of parts configured to store ancillary items used by an angler on a fishing boat, comprising: apparatus comprising an elongate anchoring member configured to be anchored in a fishing rod holder on the fishing boat, the elongate anchoring member comprising a shaft, a resilient member mounted on the shaft, and a compression mechanism configured to radially expand the resilient member; and a cup-like receptacle mounted on one axial end of the elongate anchoring member; and a plurality of preformed components configured to be interchangeably coupled to the cup-like receptacle, the plurality of preformed components having different profiles which correspond to different ancillary items such that, when one of the preformed components is coupled to the cup-like receptacle, the respective profile is configured to retain a corresponding ancillary item in the cup-like receptacle when placed therein.
